(19) United States
(12) Patent Application Publication
(10) Pub. No.: US 2007/0215116 A1
(43) Pub. Date: Sep. 20, 2007

(54) Common Rail Injector

(76) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/587,002

(22) PCT Filed: Feb. 18, 2005
(86) PCT No.: PCT/EP05/50715

§ 371 Date: Oct. 20, 2006

(30) Foreign Application Priority Data
Apr. 20, 2004 (DE) 10 2004 018 931.5

(51) Int. Cl. F02M 51/00

(52) U.S. Cl. 123/472

(57) ABSTRACT

A common rail injector having an injector housing that has a fuel inlet, which communicates with a central high-pressure fuel source outside the injector housing and with a pressure chamber inside the injector housing, from the latter of which, depending on the pressure in a control chamber, highly pressurized fuel is injected into a combustion chamber of an internal combustion engine when a nozzle needle lifts away from its seat, and in which the pressure in the control chamber is directly controlled by a piezoelectric actuator. The end of the nozzle needle oriented away from the combustion chamber accommodates a control chamber delimiting sleeve that can move back and forth and reduce the size of the control chamber-pressurized end surface of the nozzle needle oriented away from the combustion chamber.

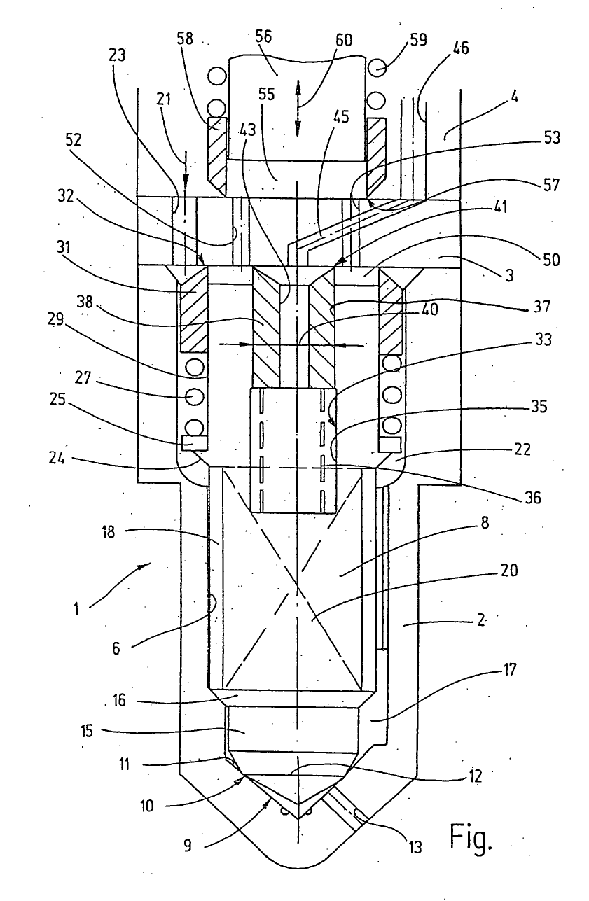

The invention relates to a common rail injector having an injector housing that has a fuel inlet, which communicates with a central high-pressure fuel source outside the injector housing and with a pressure chamber inside the injector housing, from the latter of which, depending on the pressure in a control chamber, highly pressurized fuel is injected into a combustion chamber of an internal combustion engine when a nozzle needle lifts away from its seat, and in which the pressure in the control chamber is directly controlled by an actuator, in particular a piezoelectric actuator.

If the pressure in the control chamber is directly controlled by a deformation of the actuator, in particular a piezoelectric actuator, then this is also referred to as direct nozzle needle control. Conventional common rail injectors with direct nozzle needle control require a relatively large amount of space, particularly in length.

The object of the present invention is to create a common rail injector having an injector housing that has a fuel inlet, which communicates with a central high-pressure fuel source outside the injector housing and with a pressure chamber inside the injector housing, from the latter of which, depending on the pressure in a control chamber, highly pressurized fuel is injected into a combustion chamber of an internal combustion engine when a nozzle needle lifts away from its seat, and in which the pressure in the control chamber is directly controlled by an actuator, in particular a piezoelectric actuator, which injector requires less space, particularly in length, than conventional injectors.

### DISCLOSURE OF THE INVENTION

In a common rail injector having an injector housing that has a fuel inlet, which communicates with a central high-pressure fuel source outside the injector housing and with a pressure chamber inside the injector housing, from the latter of which, depending on the pressure in a control chamber, highly pressurized fuel is injected into a combustion chamber of an internal combustion engine when a nozzle needle lifts away from its seat, and in which the pressure in the control chamber is directly controlled by an actuator, in particular a piezoelectric actuator, the object of the invention is attained by having the end of the nozzle needle oriented away from the combustion chamber accommodate a control chamber delimiting sleeve that can move back and forth and reduce the size of the control chamber-pressurized end surface of the nozzle needle oriented away from the combustion chamber. In the context of the present invention, a direct control of the pressure in the control chamber is understood to be the generation of a pressure drop and/or a pressure increase due to a volume change of the actuator. In order to enable such a direct control, the control chamber is able to communicate with an actuator chamber that is delimited by an end surface of the actuator or an actuator tip coupled or attached to the actuator. The control chamber delimiting sleeve artificially reduces the size of the control chamber. For this reason, the pressure difference in the control chamber required to open and close the nozzle needle can now be lower than in conventional injectors with inverse control. This offers the advantage of permitting shorter actuators to be used.

A preferred exemplary embodiment of the injector is characterized in that the outer diameter of the control chamber delimiting sleeve is smaller than the outer diameter of the nozzle needle in the region of its seat. As a result of this, the pressurized surface of the nozzle needle situated in the control chamber can be designed to be only slightly larger than the pressurized surface of the nozzle needle oriented in the opposite direction.

Another preferred exemplary embodiment of the injector is characterized in that a biting edge is provided on the radial outside of the end of the control chamber delimiting sleeve oriented away from the combustion chamber. The biting edge comes to rest in a sealed fashion against the injector housing in order to delimit the control chamber on the radial inside.

Another preferred exemplary embodiment of the injector is characterized in that the control chamber delimiting sleeve has a central through opening that communicates with a leakage oil line let into the injector housing. The leakage oil line can serve to drain leakage oil that has seeped into the interior of the control chamber delimiting sleeve. In addition, the leakage oil line relieves the pressure on the interior of the control chamber delimiting sleeve.

Another preferred exemplary embodiment of the injector is characterized in that the end of the nozzle needle oriented away from the combustion chamber has a blind hole let into it, which has a guide section in which the control chamber delimiting sleeve is guided in a sealed fashion. This makes it possible for the nozzle needle to move without the control chamber delimiting sleeve moving along with it.

Another preferred exemplary embodiment of the injector is characterized in that the blind hole contains a prestressing spring for the control chamber delimiting sleeve. The prestressing spring serves to keep the control chamber delimiting sleeve in contact with the injector housing when the nozzle needle is resting against its seat.

Another preferred exemplary embodiment of the injector is characterized in that the control chamber is delimited toward the radial outside by an additional control chamber delimiting sleeve, which is guided so that it can move back and forth at the end of the nozzle needle oriented away from the combustion chamber. The control chamber delimited by the two control chamber delimiting sleeves is embodied in the form of an annular chamber that is delimited in the axial direction by the injector housing and the end surface of the nozzle needle oriented away from the combustion chamber.

Another preferred exemplary embodiment of the injector is characterized in that the control chamber communicates with an actuator pressure chamber that a piezoelectric actuator delimits inside the injector housing. Preferably, the piezoelectric actuator is continuously supplied with current so that the nozzle needle is situated in the closed position. When the piezoelectric actuator is deactivated, then the pressure decreases in the actuator pressure chamber and in the control chamber with which it communicates so that the nozzle needle lifts away from its seat and uncovers at least one injection opening through which highly pressurized fuel is injected into the combustion chamber. This type of control is also referred to as inverse control.

Other advantages, features, and details of the invention ensue from the following description in which an exemplary embodiment is described in detail in conjunction with the drawing.

### DESCRIPTION OF THE EXEMPLARY EMBODIMENT

The accompanying drawing shows a longitudinal section through an exemplary embodiment of a common rail injector according to the present invention. The common rail injector has an injector housing labeled as a whole with the reference numeral 1. The injector housing 1 has a nozzle body 2, the freely extending lower end of which protrudes into the combustion chamber of the internal combustion engine to be supplied. With its upper end surface oriented away from the combustion chamber, the nozzle body 2 is clamped axially against an intermediate body 3 and an injector body 4 by means of a retaining nut (not shown).

An axial guide bore 6 is let into the nozzle body 2. A nozzle needle 8 is guided so that it can move axially in the guide bore 6. At the tip 9 of the nozzle needle 8, a sealing edge 10 is provided, which cooperates with a sealing seat or sealing surface 11, which is provided on the nozzle body 2. When the sealing edge 10 of the tip 9 of the nozzle needle 8 is resting against the sealing seat 11, then an injection opening 13 in the nozzle body 2 is closed. When the sealing edge 10 of the nozzle needle tip 9 lifts away from its sealing seat 11, then highly pressurized fuel is injected through the injection opening 13—or through several injection openings—into the combustion chamber of the internal combustion engine.

Extending away from the tip 9, the nozzle needle 8 has a pressure chamber section 15 that is essentially the shape of a circular cylinder. The pressure chamber section 15 is adjoined by a section 16 that widens in the form of a truncated cone. The sections 15 and 16 are situated in a pressure chamber 17 contained in the nozzle body 2. The section 16 that widens in the form of a truncated cone is adjoined by an essentially circular, cylindrical guide section 18. The guide section 18 is guided so that it can move back and forth in the axial guide bore 6 of the nozzle body 2. A flattened area 20—or several flattened areas—that is/are provided in the guide section achieve(s) a fluid connection between the pressure chamber 17 and a nozzle spring chamber 22 situated at the end of the nozzle body 2 oriented away from the combustion chamber.

An arrow 21 indicates that highly pressurized fuel is fed into the nozzle spring chamber 22 via an inlet conduit 23, which is let into the intermediate body 3 and communicates with a high-pressure source (not shown). From the nozzle spring chamber 22, the highly pressurized fuel flows past the flattened area 20 and into the pressure chamber 17. The high-pressure fuel source (not shown) is also referred to as a common rail.

Adjoining the guide section 18, the nozzle needle 8 is provided with a collar 24 that provides a stop for a spring collar 25. The spring collar 25 supports one end of a prestressed nozzle spring 27 placed and/or guided radially outside an essentially circular, cylindrical control section 29 provided at the end of the nozzle needle 8 oriented away from the combustion chamber.

An outer control chamber delimiting sleeve 31 that has a biting edge 32 is guided on the control section 29 at the end of the nozzle needle 8 oriented away from the combustion chamber. The biting edge 32 of the outer control chamber delimiting sleeve 31 rests against the intermediate body 3.

The end of the nozzle needle 8 oriented away from the combustion chamber has a central blind hole 33 let into it, which constitutes a receptacle 35 for a sealing spring 36. Toward the end of the nozzle needle 8 oriented away from the combustion chamber, the blind hole 33 transitions into a guide section 37 in which an inner control chamber delimiting sleeve 38 is guided so that it can move back and forth. The inner control chamber delimiting sleeve 38 has an outer diameter 40 that is slightly smaller than the outer diameter 12 of the sealing edge 10 at the tip 9 of the nozzle needle 8.

The end of the inner control chamber delimiting sleeve 38 oriented away from the combustion chamber is provided with a biting edge 41 with which the inner control chamber delimiting sleeve 38 rests against the intermediate body 3. The inner control chamber delimiting sleeve 38 has a central through opening 43 that communicates with a leakage oil connecting line 45 that is provided in the intermediate body 3 and, inside the surface of the intermediate body 3 delimited by the biting edge 41, feeds into the inner chamber delimited by the inner control chamber delimiting sleeve 38. The leakage oil connecting line 45 in the intermediate body 3 continues on in the form of a leakage oil line 46 in the injector body 4.

The inner control chamber delimiting sleeve 38 and the outer control chamber delimiting sleeve 31 radially delimit a control chamber 50 that is axially delimited by the intermediate body 3 and the end surface of the nozzle needle 8 oriented away from the combustion chamber. The control chamber 50 is embodied in the form of an annular chamber, which, via control chamber connecting lines 52 and 53 provided in the intermediate body 3, communicates with an actuator pressure chamber contained in the injector body 4. The actuator pressure chamber 55 is delimited in the axial direction by an actuator 56 at the end oriented away from the combustion chamber and by the intermediate body 3 at the end oriented toward the combustion chamber. Toward the radial outside, the actuator pressure chamber 55 is delimited by an actuator sleeve 58. The actuator pressure chamber 55 communicates via connecting lines (not shown) with the inlet conduit 23 so that the actuator pressure chamber 55 is filled with highly pressurized fuel. The actuator sleeve 58 is provided with a biting edge 57 that rests against the intermediate body 3. The opposite end of the actuator sleeve 58 is acted on by an actuator spring 59 that keeps the biting edge 57 of the actuator sleeve 58 in contact with the intermediate body 3.

The actuator 56 is a piezoelectric actuator that has a larger volume when supplied with current than when it is without current. A double arrow 60 indicates that the actuator 56 can deform, increasing or decreasing the pressure in the actuator pressure chamber 55 and the control chamber 50 with which it communicates.

When the actuator, which is otherwise continuously supplied with current, is deactivated, then this decreases the pressure in the actuator pressure chamber 55 and the control chamber 50 with which it communicates. The pressurized surfaces of the nozzle needle 8 are designed so that this pressure drop causes the sealing edge 10 of the nozzle needle 8 to lift away from the sealing seat 11 so that highly pressurized fuel from the pressure chamber 17 is injected through the injection opening of 13 into the combustion chamber of the internal combustion engine.

The gas back pressure of the combustion chamber acts on the region of the nozzle needle underneath the sealing edge 10. The high pressure supplied via the inlet conduit 23, which is also referred to as common rail pressure, acts on the region of the nozzle needle 8 above the sealing edge 10. If the nozzle is to be opened, then a force equilibrium in the region of the control chamber 50 must be achieved in relation to the common rail pressure acting on the diameter 12. In order to lift the nozzle needle 8, the pressure in the control chamber 50 is decreased with the aid of the actuator 56.

The use of the inner control chamber delimiting sleeve 38 is able to artificially reduce the size of the control chamber 50 since leakage oil pressure prevails on the interior of the inner control chamber delimiting sleeve 38. The diameter 40 of the inner control chamber delimiting sleeve 38 is preferably designed so that it is smaller than the diameter 12 of the sealing edge 10 of the nozzle needle 8. In the design process, care must be taken that the sum of the forces in the region of the sealing seat 11 is less than the force that results from the compressive forces acting in the control chamber 50 and the spring forces of the nozzle spring 27 and the sealing spring 36.

1-8. (canceled)

9. In a common rail injector having an injector housing that has a fuel inlet, which communicates with a central high-pressure fuel source outside the injector housing and with a pressure chamber inside the injector housing, from the latter of which, depending on the pressure in a control chamber, highly pressurized fuel is injected into a combustion chamber of an internal combustion engine when a nozzle needle lifts away from its seat, and in which the pressure in the control chamber is directly controlled by a piezoelectric actuator, the improvement wherein the end of the nozzle needle oriented away from the combustion chamber accommodates a control chamber delimiting sleeve mounted for movement back and forth to reduce the size of the control chamber-pressurized end surface of the nozzle needle oriented away from the combustion chamber.

10. The common rail injector according to claim 9, wherein the outer diameter of the control chamber delimiting sleeve is smaller than the outer diameter of the nozzle needle in the region of its seat.

11. The common rail injector according to claim 9, wherein the control chamber delimiting sleeve comprises a biting edge on its radial outside at the end oriented away from the combustion chamber.

12. The common rail injector according to claim 10, wherein the control chamber delimiting sleeve comprises a biting edge on its radial outside at the end oriented away from the combustion chamber.

13. The common rail injector according to claim 11, wherein the control chamber delimiting sleeve comprises a central through hole that communicates with a leakage oil line that is let into the injector housing.

14. The common rail injector according to claim 12, wherein the control chamber delimiting sleeve comprises a central through hole that communicates with a leakage oil line that is let into the injector housing.

15. The common rail injector according to claim 9, further comprising a blind hole let into the end of the nozzle needle oriented away from the combustion chamber, which blind hole has a guide section in which the control chamber delimiting sleeve is guided in a sealed fashion.

16. The common rail injector according to claim 10, further comprising a blind hole let into the end of the nozzle needle oriented away from the combustion chamber, which blind hole has a guide section in which the control chamber delimiting sleeve is guided in a sealed fashion.

17. The common rail injector according to claim 11, further comprising a blind hole let into the end of the nozzle needle oriented away from the combustion chamber, which blind hole has a guide section in which the control chamber delimiting sleeve is guided in a sealed fashion.

18. The common rail injector according to claim 13, further comprising a blind hole let into the end of the nozzle needle oriented away from the combustion chamber, which blind hole has a guide section in which the control chamber delimiting sleeve is guided in a sealed fashion.

19. The common rail injector according to claim 13, further comprises a prestressing spring in the blind hole in the nozzle needle for the control chamber delimiting sleeve.

20. The common rail injector according to claim 11, further comprises a prestressing spring in the blind hole in the nozzle needle for the control chamber delimiting sleeve.
